(19) United States
(12) Patent Application Publication
(10) Pub. No.: US 2013/0265290 A1
(43) Pub. Date: Oct. 10, 2013

(54) DISPLAY APPARATUS

(71) Applicant: Seung Jun LEE, Yongin-City (KR)

(72) Inventor: Seung Jun LEE, Yongin-City (KR)

(21) Appl. No.: 13/741,520

(22) Filed: Jan. 15, 2013

(30) Foreign Application Priority Data
Apr. 4, 2012 (KR) 10-2012-0035050

(51) Int. Cl. G09G 3/34

(52) U.S. Cl. CPC G09G 3/34
USPC 345/211; 345/82

(57) ABSTRACT

A display apparatus includes a display panel including a pixel displaying an image in response to a driving signal and a voltage line supplying a driving voltage to the pixel, a first printed circuit board part electrically connected to a first end of the voltage line to provide the driving voltage, a second printed circuit board part electrically connected to a second end of the voltage line to provide the driving voltage, a power source supplying part supplied with a power source to generate the driving voltage, the power source supplying part supplying the driving voltage to the first and second printed circuit board parts, a first connection part transmitting the driving voltage from the power source supplying part to the first printed circuit board part, and a second connection part transmitting the driving voltage from the power source supplying part to the second printed circuit board part.

### CROSS-REFERENCE TO RELATED APPLICATIONS

Korean Patent Application No. 10-2012-0035050, filed on Apr. 4, 2012, and entitled, “Display Apparatus,” is incorporated by reference herein in its entirety.

### BACKGROUND

1. Field

Embodiments relate to display apparatuses and, more particularly, to display apparatuses driven by a simultaneous emission method.

2. Description of the Related Art

Generally, organic light emitting display apparatuses may display images by organic light emitting devices which generate light by recombination of electrons and holes. The organic light emitting display apparatuses may have fast response speed and low power consumption.

The organic light emitting display apparatuses may be categorized into one of a passive matrix type-organic light emitting display apparatus (PMOLED) and an active matrix type-organic light emitting display apparatus (AMOLED) according to a method driving the organic light emitting device.

### SUMMARY

Embodiments are directed to a display apparatus including a display panel including a pixel displaying an image in response to a driving signal and a voltage line supplying a driving voltage to the pixel, a first printed circuit board part electrically connected to a first end of the voltage line so as to provide the driving voltage, a second printed circuit board part electrically connected to a second end of the voltage line so as to provide the driving voltage, a power source supplying part supplied with a power source to generate the driving voltage, the power source supplying part supplying the driving voltage to the first printed circuit board part and the second printed circuit board part, a first connection part transmitting the driving voltage from the power source supplying part to the first printed circuit board part, and a second connection part transmitting the driving voltage from the power source supplying part to the second printed circuit board part.

The first printed circuit board part may be located on one portion of a back side of the display panel, the one portion being adjacent to the first end of the voltage line. The second printed circuit board part may be located on another portion of the back side of the display panel, the another portion being adjacent to the second end of the voltage line. The power source supplying part may be located on the back side of the display panel between the first printed circuit board part and the second printed circuit board part.

The display panel may be divided into a first region and a second region. The first printed circuit board part may include a first printed circuit board driving the first region and a second printed circuit board driving the second region. The second printed circuit board part may include a third printed circuit board driving the first region and a fourth printed circuit board driving the second region.

The first connection part may include a first connection film transmitting the driving voltage from the power source supplying part to the first printed circuit board and a second connection film transmitting the driving voltage from the power source supplying part to the second printed circuit board. The second connection part may include a third connection film transmitting the driving voltage from the power source supplying part to the third printed circuit board and a fourth connection film transmitting the driving voltage from the power source supplying part to the fourth printed circuit board.

The driving voltage may be supplied from the first to fourth printed circuit boards to the display panel. The display apparatus may further include a first film electrically connecting the display panel and the first printed circuit board to each other, a second film electrically connecting the display panel and the second printed circuit board to each other, a third film electrically connecting the display panel and the third printed circuit board to each other, and a fourth film electrically connecting the display panel and the fourth printed circuit board to each other.

The first printed circuit board may include a first timing controller receiving a first external control signal and a first image signal corresponding to the first region of the display panel from an image board. The second printed circuit board may include a second timing controller receiving a second external control signal and a second image signal corresponding to the second region of the display panel from the image board.

A panel driving part driving the display panel may include a gate driving part, a first data driving part, a second data driving part, and a control line driving part. The gate driving part may receive a gate-side control signal from the first timing controller. The first data driving part may receive a first control signal and a first image signal from the first timing controller. The second data driving part may receive a second control signal and a second image signal from the second timing controller. The control line driving part may receive a third control signal from the first timing controller.

The power source supplying part may receive a fourth control signal from the first timing controller and may then apply the driving voltage to the display panel.

The display apparatus may further include a fifth film electrically connecting the display panel and the first printed circuit board, and a sixth film electrically connecting the display panel and the second printed circuit board. The first data driving part may be located on the fifth film. The second data driving part may be located on the sixth film.

The display panel may include a plurality of gate lines, a plurality of data lines, a plurality of control lines, a plurality of voltage lines, and a plurality of pixels. The gate driving part sequentially outputs gate voltages to the plurality of gate lines. The data driving part may output data voltages to the plurality of data lines, respectively. The control line driving part may provide control signals to the plurality of control lines.

Each of the pixels may include a switching transistor, a driving transistor, a control transistor, an image maintaining capacitor, and an organic light emitting device. The switching transistor may be connected to one of the plurality of gate lines and one of the plurality of data lines and outputs the data voltage in response to the gate voltage. The driving transistor may control an amount of a current outputted from the control transistor in response to the data voltage outputted from the switching transistor. The control transistor may be connected to one of the plurality of voltage lines and the driving transistor and may output the driving voltage in response to the control signal of one of the plurality of control lines. The image maintaining capacitor may be disposed between the one of the plurality of data lines and the one of the plurality of voltage lines. The image maintaining capacitor may store charges corresponding to a voltage difference between the data voltage and the driving voltage to maintain a turn-on state of the driving transistor. The organic light emitting device may emit light in response to a current outputted from the driving transistor.

The display apparatus may further include a first cable connected to the image board and transmitting the first external control signal and the first image signal to the first printed circuit board, and a second cable connected to the image board and transmitting the second external signal and the second image signal to the second printed circuit board. The first cable and the second cable may be spaced apart from the first connection film and the second connection film and may be disposed between the first connection film and the second connection film.

### BRIEF DESCRIPTION OF THE DRAWINGS

Features will become apparent to those of skill in the art by describing in detail exemplary embodiments with reference to the attached drawings in which:

FIG. 1 is a block diagram illustrating a display apparatus according to some embodiments;

FIG. 2 is an equivalent circuit diagram illustrating one of pixels provided to a display panel of FIG. 1;

FIG. 3 illustrates a driving operation of the display apparatus of FIG. 1;

FIG. 4 is a plan view illustrating a back side of the display apparatus of FIG. 1;

FIG. 5 is a plan view illustrating a flow of a current applied to the display apparatus of FIG. 4 by a driving voltage; and

FIG. 6 is a plan view illustrating a back side of a display apparatus according to other embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It is also to be understood that when an element is referred to as being “connected to” another element, it can be directly connected to the other element, or intervening elements may be present. In contrast, when an element is referred to as being “directly connected to” another element or layer, there are no intervening elements or layers present. Like reference numerals refer to like elements throughout.

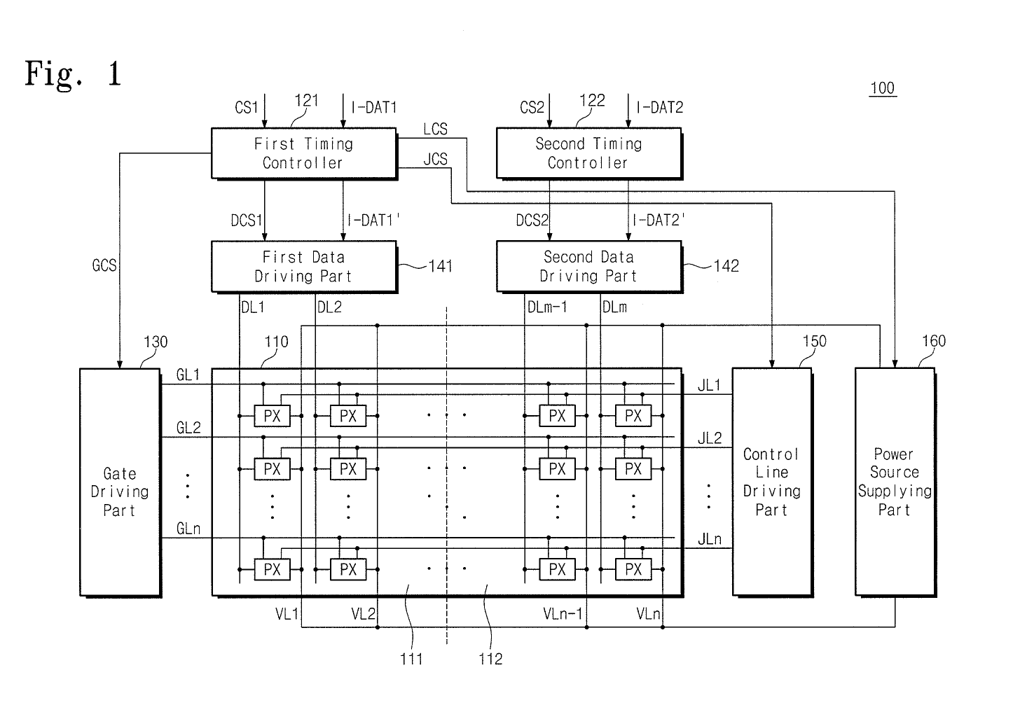

FIG. 1 is a block diagram illustrating a display apparatus according to some embodiments. Referring to FIG. 1, a display apparatus 100 may include a display panel 110, a first timing controller 121, a second timing controller 122, a gate driving part 130, a first data driving part 141, a second data driving part 142, a control line driving part 150, and a power source supplying part 160.

The display panel 110 includes a plurality of gate lines GL1 to GLn, a plurality of data lines DL1 to DLm, a plurality of control lines JL1 to JLn, and a plurality of voltage lines VL1 to VLn.

The plurality of gate lines GL1 to GLn are connected to the gate driving part 130 and receive gate voltages from the gate driving part 130. The plurality of data lines DL1 to DLm are connected to the first data driving part 141 and the second data driving part 142 and receive data voltages from the first data driving part 141 and the second data driving part 142. The plurality of control lines JL1 to JLn are connected to the control line driving part 150 and receive control signals from the control line driving part 150. The plurality of voltage lines VL1 to VLn are connected to the power source supplying part 160 and receive driving voltages ELVDD from the power source supplying driving part 160.

A plurality of pixel regions are defined in the display panel 110 by the plurality of gate lines GL1 to GLn, the plurality of data lines DL1 to DLm, the plurality of control lines JL1 to JLn, and the plurality of voltage lines VL1 to VLn. A plurality of pixels PX may be disposed in the plurality of the pixel regions, respectively.

In other embodiments, the gate driving part 130 and the control line driving part 150 may be mounted in the display panel 110.

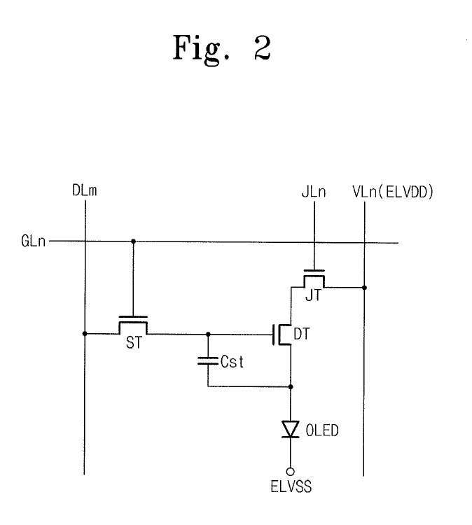

FIG. 2 is an equivalent circuit diagram illustrating one of pixels provided to a display panel of FIG. 1. The pixels PX in FIG. 1 may have the same elements as each other. Thus, an equivalent circuit of one pixel PX will be described with reference to FIG. 2, and the description will not be repeated with respect to the other pixels PX.

Referring to FIG. 2, the pixel PX includes a switching transistor ST, a driving transistor DT, a control transistor JT, an image maintaining capacitor Cst, and an organic light emitting device OLED.

The switching transistor ST includes an input electrode connected to the m-th data line DLm of the data lines DL1 to DLm, a control gate connected to the n-th gate line GLn of the gate lines GL1 to GLn, and an output electrode connected to the driving transistor DT. Thus, the switching transistor ST is turned on in response to the gate voltage applied through the n-th gate line GLn, so that the data voltage applied from the m-th data line DLm is applied to the driving transistor DT through the output electrode.

The driving transistor DT includes a control electrode connected to the output electrode of the switching transistor ST, an input electrode connected to an output electrode of the control transistor JT, and an output electrode connected to the organic light emitting device OLED. Thus, driving transistor DT is turned on in response to the data voltage of the output electrode of the switching transistor DT, so that a voltage of the output electrode of the control transistor JT is applied to the organic light emitting device OLED.

The control transistor JT includes a control electrode connected to the n-th control line JLn of the control lines JL1 to JLn, an input electrode connected to the n-th voltage line VLn of the voltage lines VL1 to VLn, and an output electrode connected to the driving transistor DT. Thus, if the control signal is applied to the n-th control line JLn, the control transistor JT is turned on, so that the driving voltage ELVDD is applied to the input electrode of the driving transistor DT.

The amount of current flowing through the output electrode of the driving transistor DT is varied by the data voltage supplied from the switching transistor ST and the driving voltage ELVDD supplied from the control transistor JT.

The image maintaining capacitor Cst is connected between the output electrode of the switching transistor ST and the output electrode of the driving transistor DT. Charges are accumulated in the image maintaining capacitor Cst by the data voltage outputted from the output electrode of the switching transistor ST and the driving voltage ELVDD. The image maintaining capacitor Cst accumulates the charges after the switching transistor ST is turned off so as to maintain the turned-on state of the driving transistor DT for a predetermined time.

The organic light emitting device OLED may include a diode including an anode connected to the output electrode of the driving transistor DT and a cathode to which a common voltage ELVSS is inputted. Thus, the organic light emitting device OLED may generate light having a predetermined brightness in correspondence to the voltage outputted from the output electrode of the driving transistor DT.

Additionally, the display apparatus may be driven by a progressive emission method or a simultaneous emission method. In some embodiments, the display apparatus may be driven by the simultaneous emission method. According to the simultaneous emission method, gate signals may be sequentially scanned to the plurality of gate lines GL1 to GLn so as to sequentially apply the data voltages to the plurality of pixels PX by row unit in a period of one frame. After the data voltages are inputted to all of the pixels PX disposed in the display panel, the driving voltage ELVDD is supplied in a lump, so that the pixels PX are operated simultaneously.

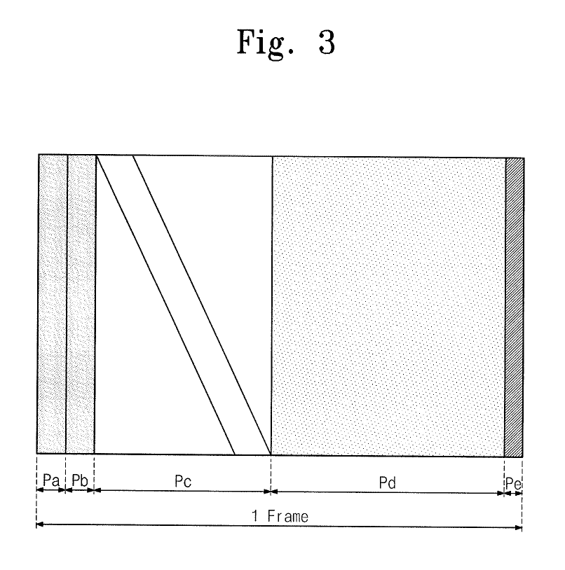

FIG. 3 illustrates a driving operation of the display apparatus of FIG. 1. Referring to FIG. 3, the one frame may be divided into a reset section Pa, a threshold voltage compensation section Pb, a scan section (i.e., data input) Pc, a light emitting section Pd, and a light emitting off section Pe.

The data voltage applied to each of the pixels PX is reset in the reset section Pa. A reset voltage may be applied to the anode of the organic light emitting device OLED in the reset section Pa. The reset voltage may be lower than the common voltage ELVSS applied to the cathode of the organic light emitting device OLED. Thus, the organic light emitting device OLED does not emit light during the reset section Pa, such that the organic light emitting device OLED may be reset.

Threshold voltages of the driving transistors DT in all of the pixels PX of the display panel 110 are stored in the respective image maintaining capacitors Cst of the pixels PX during the threshold voltage compensation section Pb. Thus, when the data voltage is applied to each of the pixels PX, an error caused by the threshold voltage of the driving transistor DT may be avoided.

In the scan section Pc, the gate signals are sequentially applied to the pixels PX connected to the plurality of gate lines GL1 to GL2, so that the data voltages are applied to the plurality of date lines DL1 to DLm.

In the light emitting section Pd, the driving voltage ELVDD corresponding to the data voltage stored in each of the pixels PX is applied to the organic light emitting device OLED in each of the pixels PX, such that the organic light emitting devices OLED in the pixels PX emit light simultaneously.

In the light emitting off section Pe, the driving voltage ELVDD is applied at a low level, so that the emission of the organic light emitting devices OLED is turned off.

As described above, the one frame may be generated by the sections Pa, Pb, Pc, Pd, and Pe. The sections Pa, Pb, Pc, Pd and Pe may be repeatedly performed to realize subsequent frames.

Referring to FIG. 1 again, the display panel 110 may include a first region 111 and a second region 112.

A first external control signal CS1 and a first image signal I-DAT1 are inputted to the first timing controller 121 from an image board (not shown), and a second external control signal CS2 and a second image signal I-DAT2 are inputted to the second timing controller 122 from the image board.

The first and second image signals I-DAT1 and I-DAT2 are inputted to the first and second timing controller 121 and 122 by a frame unit.

The first timing controller 121 generates a gate-side control signal GCS for controlling the driving of the gate driving part 130, a first control signal DCS1 for controlling the first data driving part 141, and a third control signal JCS for controlling the control line driving part 150 by using the first external control signal CS1. The first timing controller 121 is synchronized with the first control signal DCS1, thereby outputting first image data I-DAT1′ to the first data driving part 141.

The second timing controller 122 generates a second control signal DCS2 for controlling the second data driving part 142 and is synchronized with the second control signal DCS2, thereby outputting second image data I-DAT2′ to the second data driving part 142.

The gate driving part 130 responds to the gate-side control signal GCS to sequentially output the gate voltages to the plurality of gate lines GL1 to GLn. The first data driving part 141 may convert the first image data I-DAT1′ into some of the data voltages, and the second data driving part 142 may convert the second image data I-DAT2′ into others of the data voltages. Thereafter, the first and second data driving parts 141 and 142 may be synchronized with the first and second control signals DCS1 and DCS2 to output the data voltages into the plurality of data lines DL1 to DLm, respectively.

The control line driving part 150 responds to the third control signal JCS inputted from the first timing controller 121, so that the control line driving part 150 applies the control signals to the plurality of control lines JL1 to JLn simultaneously.

The power source supplying part 160 receives a fourth control signal LCS, so that the power source supplying part 160 controls a voltage level of the driving voltage ELVDD of each of the regions and applies the driving voltages ELVDD to the plurality of voltage lines VL1 to VLn simultaneously.

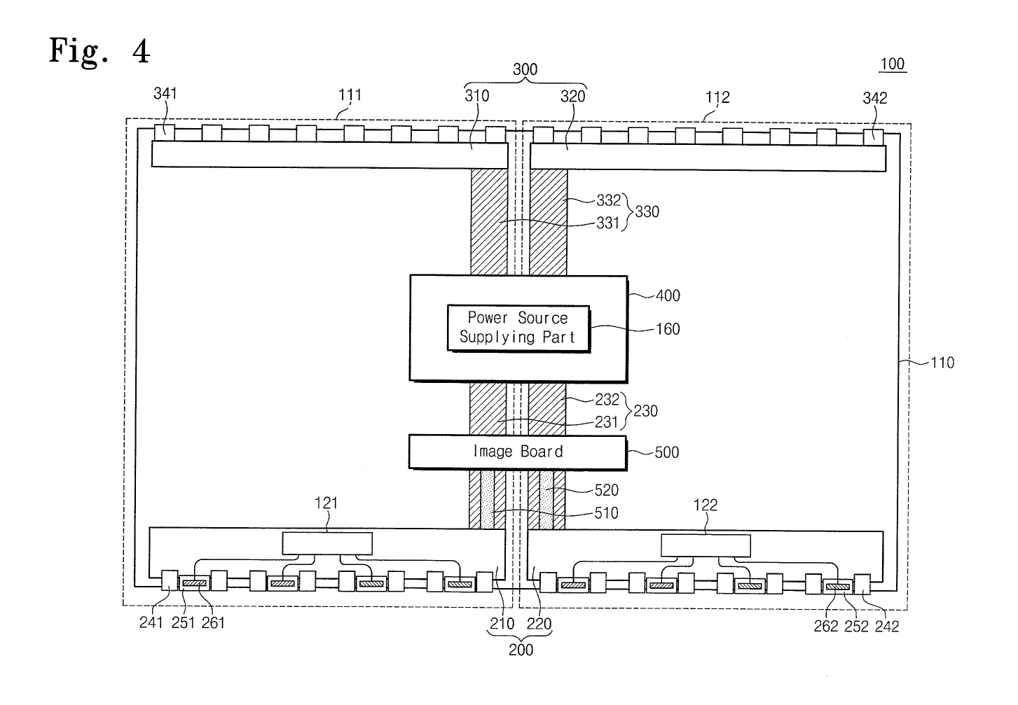

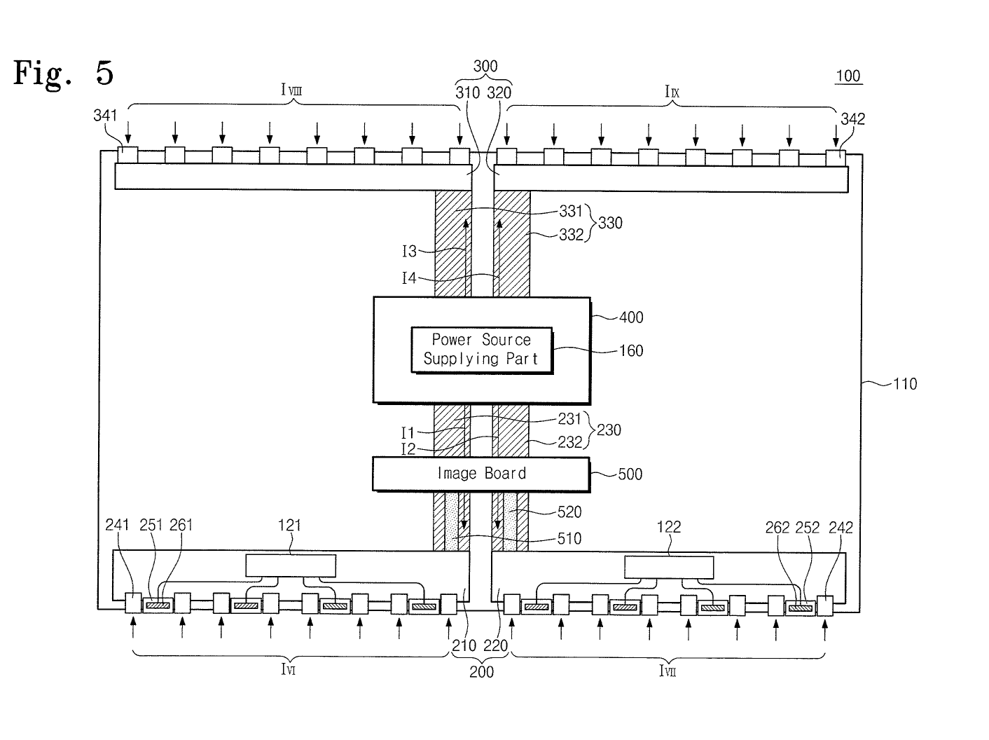

FIG. 4 is a plan view illustrating a back side of the display apparatus of FIG. 1. FIG. 5 is a plan view illustrating a flow of current applied to the display apparatus of FIG. 4 by a driving voltage.

Referring to FIG. 4, a power source supplying board 400 and an image board 500 are disposed on a back side of the display panel 110. The power source supplying part 160 may be disposed on the power source supplying board 400. The image board 500 supplies the first external control signal CS1 and the first image signal I-DAT1 to the first timing controller 121 and supplies the second external control signal CS2 and the second image signal I-DAT2 to the second timing controller 122.

The display apparatus 100 may further include a first printed circuit board part 200 and a second printed circuit board part 300. The first printed circuit board part 200 may be electrically connected to first ends of the plurality of voltage lines VL1 to VLn so as to supply the driving voltages ELVDD. The second printed circuit board part 300 may be electrically connected to second ends of the plurality of the voltage lines VL1 to VLn so as to supply the driving voltages ELVDD.

The first printed circuit board part 200 may include a first printed circuit board 210 and a second printed circuit board 220. The second printed circuit board part 300 may include a third printed circuit board 310 and a fourth printed circuit board 320.

As illustrated in FIG. 4, the first printed circuit board 210 may be disposed at a left-side bottom part of the display panel 110 in FIG. 4. The first timing controller 121 may be mounted on the first printed circuit board 210. The second printed circuit board 220 may be disposed at a right-side bottom part of the display panel 110 in FIG. 4. The second timing controller 122 may be mounted on the second printed circuit board 220.

The first printed circuit board 210 may be electrically connected to the display panel 110 through a plurality of first films 241, and the second printed circuit board 220 may be electrically connected to the display panel 110 through a plurality of second films 242.

The third printed circuit board 310 may be disposed at a left-side top part of the display panel 110 in FIG. 4, and the fourth printed circuit board 320 may be disposed at a right-side top part of the display panel 110 in FIG. 4.

The third printed circuit board 310 may be electrically connected to the display panel 110 through a plurality of third films 341, and the fourth printed circuit board 320 may be electrically connected to the display panel 110 through a plurality of fourth films 342.

Additionally, the display apparatus 100 may further include a first connection part 230 and a second connection part 330. The first connection part 230 transmits the driving voltage ELVDD from the power source supplying part 160 to the first printed circuit board part 200, and the second connection part 330 transmits the driving voltage ELVDD from the power source supplying part 160 to the second printed circuit board part 300.

The first connection part 230 includes a first connection film 231 and a second connection film 232. The first connection film 231 electrically connects the power source supplying board 400 to the first printed circuit board 210, and the second connection film 232 electrically connects the power source supplying board 400 to the second printed circuit board 220.

The second connection part 330 includes a third connection film 331 and a fourth connection film 332. The third connection film 331 electrically connects the power source supplying board 400 to the third printed circuit board 310, and the fourth connection film 332 electrically connects the power source supplying board 400 to the fourth printed circuit board 320.

Thus, the first to fourth printed circuit boards 210, 220, 310, and 320 simultaneously apply the driving voltage ELVDD to the plurality of the voltage lines VL1 to VLn provided to the display panel 110 through the first to fourth films 241, 242, 341, and 342, respectively.

Additionally, the first to fourth printed circuit boards 210, 220, 310, and 320 simultaneously apply the control signals supplied from the control driving part 150 of FIG. 1 to the plurality of control lines JL1 to JLn through the first to fourth films 241, 242, 341, and 342, respectively.

Furthermore, the display apparatus 100 may further include a plurality of fifth films 251 electrically connecting the display panel 110 and the first printed circuit board 210 to each other, and a plurality of sixth films 252 electrically connecting the display panel 110 and the second printed circuit board 220 to each other.

The first data driving part 141 of FIG. 1 includes a plurality of first data driving chips 261 respectively mounted on the plurality of fifth films 251. The first data driving chips 261 supply the data voltages to the data lines DL1 to DLm disposed in the first region of the display panel 110.

The second data driving part 142 of FIG. 1 includes a plurality of second data driving chips 262 respectively mounted on the plurality of sixth films 252. The second data driving chips 262 supply the data voltages to the data lines DL1 to DLm disposed in the second region of the display panel 110.

Additionally, the image board 500 may further include a first cable 510 electrically connected to the first printed circuit board 210 and a second cable 520 electrically connected to the second printed circuit board 220. The image board 500 applies a power source control signal (not shown) for generating the driving voltage ELVDD to the first printed circuit board part 200 through the first and second cables 510 and 520. The first printed circuit board part 200 applies the power source control signal to the power source supplying part 160. The power source supplying part 160 generates the driving voltages ELVDD supplied to the display panel 110.

As described above, the power source supplying part 160 generates the driving voltage ELVDD for simultaneous emission driving, and then applies the driving voltage ELVDD to the first to fourth printed circuit boards 210, 220, 310, and 320 through the first to fourth connection films 231, 232, 331, and 332. The first to fourth printed circuit boards 210, 220, 310, and 320 apply the driving voltage ELVDD to the display panel 110.

Thus, the driving voltage ELVDD may be divided to be respectively applied to both sides (i.e., the first and second regions) of the display panel 100 from the power source supplying part 160, such that a constant current may be applied to the pixels PX of the display panel 110. As a result, brightness uniformity of the display apparatus 100 may be improved.

FIG. 5 shows a divided flow of current into the display panel 110 from the power source supplying board 400.

When the total amount of the currents outputted from the power source supplying board 400 is defined as an input current I_input, the input current I_input is represented as the following equation 1 by Kirchhoff's current law.

I_input=I1+I2+I3+I4=(I_{VI})+(I_{VII})+(I_{VIII})+(I_{IX}) [Equation 1]

where a first current I1 is a current applied to the first printed circuit board 210, a second current I2 is a current applied to the second printed circuit board 220, a third current I3 is a current applied to the third printed circuit board 310, and a fourth current I4 is a current applied to the fourth printed circuit board 320. Current I_{VI} represents a sum of currents applied to the display panel 110 through the first films 241, current I_{VII} represents a sum of currents applied to the display panel 110 through the second films 242, current I_{VIII} represents a sum of currents applied to the display panel 110 through the third films 341, and current I_{IX} represents a sum of currents applied to the display panel 110 through the fourth films 342.

An experiment was performed for confirming a temperature variation in the display case 110 according to a comparative example and an example according to embodiments. In a first case (a comparative example), the first and second currents I1 and I2 were applied to the first and second printed circuit boards to apply an input current to all of the pixels of a display panel. In a second case (according to embodiments), divided first to fourth currents I1, I2, I3, and I4 were applied to the first to fourth printed circuit boards 210, 220, 310, and 320 to apply the input current to all of the pixels PX of the display panel 110. The temperature of a current inlet part of a bottom end of the display panel 110 in the second case was about 10 degrees lower than that of the display panel in the first case.

Thus, the amount of the input current applied to the display panel 110 according to embodiments may be reduced to prevent deterioration of inlet parts of the display panel 110.

Additionally, a constant current may be applied to all of the pixels of the display panel 110 to improve the brightness uniformity of the display apparatus 110.

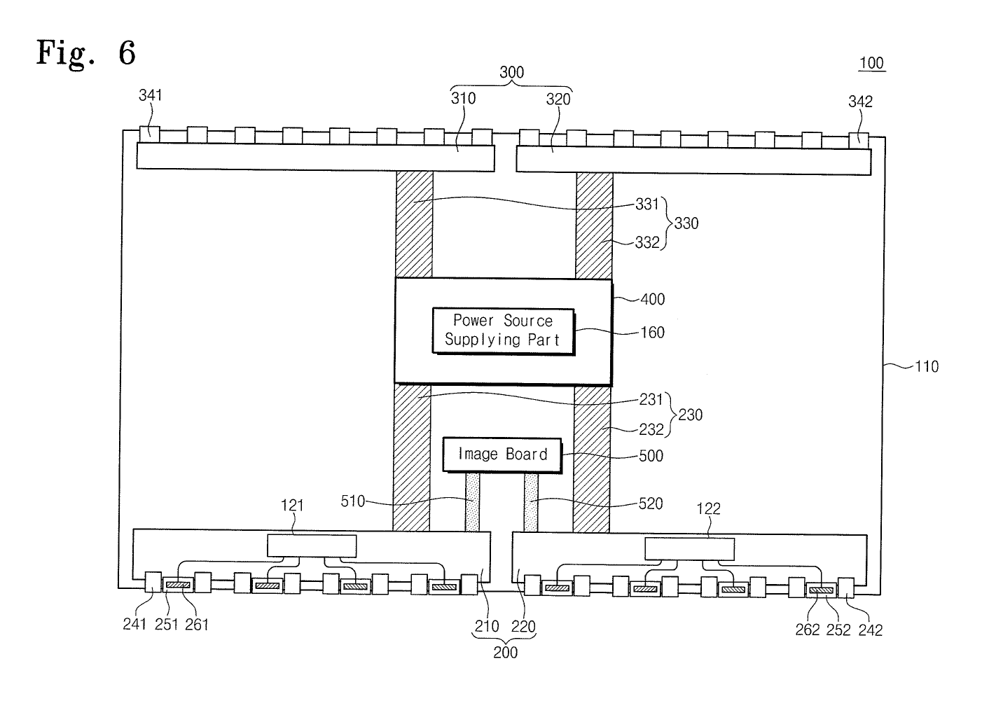

FIG. 6 is a plan view illustrating a back side of a display apparatus according to other embodiments.

Referring to FIG. 6, the first connection film 231 and the second connection film 232 may be spaced apart from the first cable 510 and the second cable 520 of the image board 500 and may be connected to the first printed circuit board 210 and the second printed circuit board 220, respectively. The first and second cables 510 and 520 may be disposed between the first and second connection films 231 and 232.

As described above, locations of connection parts connected to the first and second printed circuit boards 210 and 220 may be varied. Accordingly, it may be possible to prevent the signals supplied from the image board 500 and a driving signal of the driving voltage ELVDD supplied from the power source supplying part 160 from overlapping each other on the first and second printed circuit boards 210 and 220.

By way of summation and review, in an active matrix organic light emitting display apparatus, a driving voltage is applied to a display panel to control a current supplied to the organic light emitting device. It is desirable that the amplitude of the driving voltage be constant throughout the display panel so that the organic light emitting display apparatus may maintain a uniform brightness.

However, the brightness may be reduced by the wire resistance of the display panel as the distance from an inlet part of the driving voltage increases. Additionally, the display quality of the organic light emitting display apparatus may be deteriorated by heat generated at the inlet part.

In a display apparatus according to embodiments, a driving voltage from a power source supplying part may be divided and applied to all of pixels of a display panel through a plurality of printed circuit boards and a plurality of connection films. Thus, the amount of an inputted current applied to the display panel may be reduced to prevent deterioration of inlet parts of the display panel and to improve brightness uniformity of the display apparatus. The divided driving voltage from the power source supplying part may be applied into regions of the display panel through a first connection part electrically connected to the first printed circuit board part and a second connection part electrically connected to the second printed circuit board part.

Thus, a constant current may be applied to the all of the pixels of the display panel to improve the brightness uniformity and to prevent the deterioration of the inlet parts of the display panel to which the driving voltage is applied.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A display apparatus, comprising:
a display panel including a pixel displaying an image in response to a driving signal and a voltage line supplying a driving voltage to the pixel;
a first printed circuit board part electrically connected to a first end of the voltage line so as to provide the driving voltage;
a second printed circuit board part electrically connected to a second end of the voltage line so as to provide the driving voltage;
a power source supplying part supplied with a power source to generate the driving voltage, the power source supplying part supplying the driving voltage to the first printed circuit board part and the second printed circuit board part;
a first connection part transmitting the driving voltage from the power source supplying part to the first printed circuit board part; and
a second connection part transmitting the driving voltage from the power source supplying part to the second printed circuit board part.

2. The display apparatus as claimed in claim 1, wherein:
the first printed circuit board part is located on one portion of a back side of the display panel, the one portion being adjacent to the first end of the voltage line;
the second printed circuit board part is located on another portion of the back side of the display panel, the another portion being adjacent to the second end of the voltage line, and
the power source supplying part is located on the back side of the display panel between the first printed circuit board part and the second printed circuit board part.

3. The display apparatus as claimed in claim 2, wherein:
the display panel is divided into a first region and a second region,
the first printed circuit board part includes a first printed circuit board driving the first region and a second printed circuit board driving the second region, and
the second printed circuit board part includes a third printed circuit board driving the first region and a fourth printed circuit board driving the second region.

4. The display apparatus as claimed in claim 3, wherein:
the first connection part includes a first connection film transmitting the driving voltage from the power source supplying part to the first printed circuit board and a second connection film transmitting the driving voltage from the power source supplying part to the second printed circuit board, and
the second connection part includes a third connection film transmitting the driving voltage from the power source supplying part to the third printed circuit board and a fourth connection film transmitting the driving voltage from the power source supplying part to the fourth printed circuit board.

5. The display apparatus as claimed in claim 4, wherein:
the driving voltage is supplied from the first to fourth printed circuit boards to the display panel, and
the display apparatus further comprises:
a first film electrically connecting the display panel and the first printed circuit board to each other,
a second film electrically connecting the display panel and the second printed circuit board to each other,
a third film electrically connecting the display panel and the third printed circuit board to each other, and
a fourth film electrically connecting the display panel and the fourth printed circuit board to each other.

6. The display apparatus as claimed in claim 5, wherein:
the first printed circuit board includes a first timing controller receiving a first external control signal and a first image signal corresponding to the first region of the display panel from an image board, and
the second printed circuit board includes a second timing controller receiving a second external control signal and a second image signal corresponding to the second region of the display panel from the image board.

7. The display apparatus as claimed in claim 6, wherein:
a panel driving part driving the display panel includes a gate driving part, a first data driving part, a second data driving part, and a control line driving part,
the gate driving part receives a gate-side control signal from the first timing controller;
the first data driving part receives a first control signal and a first image signal from the first timing controller,
the second data driving part receives a second control signal and a second image signal from the second timing controller, and
the control line driving part receives a third control signal from the first timing controller.

8. The display apparatus as claimed in claim 7, wherein the power source supplying part receives a fourth control signal from the first timing controller and then applies the driving voltage to the display panel.

9. The display apparatus as claimed in claim 7, further comprising:
a fifth film electrically connecting the display panel and the first printed circuit board; and
a sixth film electrically connecting the display panel and the second printed circuit board,
wherein:
the first data driving part is located on the fifth film; and
the second data driving part is located on the sixth film.

10. The display apparatus as claimed in claim 9, wherein:
the display panel includes a plurality of gate lines, a plurality of data lines, a plurality of control lines, a plurality of voltage lines, and a plurality of pixels;
the gate driving part sequentially outputs gate voltages to the plurality of gate lines;
the data driving part outputs data voltages to the plurality of data lines, respectively; and
the control line driving part provides control signals to the plurality of control lines.

11. The display apparatus as claimed in claim 10, wherein:
each of the pixels includes a switching transistor, a driving transistor, a control transistor, an image maintaining capacitor, and an organic light emitting device,
the switching transistor is connected to one of the plurality of gate lines and one of the plurality of data lines and outputs the data voltage in response to the gate voltage,
the driving transistor controls an amount of a current outputted from the control transistor in response to the data voltage outputted from the switching transistor,
the control transistor is connected to one of the plurality of voltage lines and the driving transistor and outputs the driving voltage in response to the control signal of one of the plurality of control lines,
the image maintaining capacitor is disposed between the one of the plurality of data lines and the one of the plurality of voltage lines, the image maintaining capacitor storing charges corresponding to a voltage difference between the data voltage and the driving voltage to maintain a turn-on state of the driving transistor; and
the organic light emitting device emits light in response to a current outputted from the driving transistor.

12. The display apparatus as claimed in claim 6, further comprising:
a first cable connected to the image board and transmitting the first external control signal and the first image signal to the first printed circuit board; and
a second cable connected to the image board and transmitting the second external signal and the second image signal to the second printed circuit board.

13. The display apparatus as claimed in claim 12, wherein the first cable and the second cable are spaced apart from the first connection film and the second connection film and are disposed between the first connection film and second connection film.
